(19) United States
(12) Patent Application Publication
(10) Pub. No.: US 2021/0209619 A1
(43) Pub. Date: Jul. 8, 2021

(54) Self Encrypting/Decrypting Algorithm to create a System and Process for Secure and Rapid Exchange and Management of Arbitrary Personal or Business Data

(71) Applicant: Girish Altekar, Austin, TX (US)

(72) Inventor: Girish Altekar, Austin, TX (US)

(21) Appl. No.: 16/736,482

(22) Filed: Jan. 7, 2020

(51) Int. Cl. G06Q 30/02; G06Q 30/00; G06Q 20/20; G06F 21/62

(52) U.S. Cl. CPC G06Q 30/0201; G06F 21/6245; G06Q 20/206; G06Q 30/016

(57) ABSTRACT

A Self-Encrypting and Self-Decrypting method that enables the creation of a business process and a system that incorporates the ability for Consumers and business Users to create rapidly transferable structured repositories of their Personal data. The structured repositories of user data enable subsequent data reuse, easily, rapidly, safely and securely that eliminates possibilities of user error, and fraud. The disintermediation of personal and business data delivery eliminates 3rd party friction and creates a vastly improved Internet business environment.

### CROSS-REFERENCE TO RELATED APPLICATIONS

This application is related to U.S. Non-Provisional patent application Ser. No. 16/423,982 (WEWISPS). The WEWISPS application utilizes the technologies disclosed in the present invention to create its service framework.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### 1. Field of the Invention

This invention Intrep-ID (interchangeably referred to as Intrepid or Intrepids in this disclosure) enables a rapid but secure exchange of personal data in Internet business applications involving consumers and businesses. The invention applies to all fields where consumers and businesses must repeatedly provide the same data to multiple service-provider businesses. By facilitating this exchange between the two parties rapidly and securely, significant benefits in costs and efficiency are achieved for both, the business and the consumer.

In this document, we refer to businesses that provide services to the Consumer as Service Providers (SP or SPs) or Merchants. Users and Consumers are used interchangeably to refer to the consumer who wishes to provide SP some data to transact some business. It is quite possible the Consumer/User of the Intrepid technology is a business agent and that the data is being provided to a real-life consumer as used in common vernacular.

### 2. Description of Related Art Including Information Disclosed Under 37 CFR 1.97 and 1.98

As cloud-based services expand into all aspects of consumer lives, the need to enable rapid exchange of arbitrary data between consumers and businesses is only becoming more critical. Existing methods involving account creation, repeatedly retyping requested data, or other even more intrusive methods cause a massive waste of effort and time, introducing friction among participants. By eliminating this friction between willing participants, the present invention makes viable varied business applications with potential to enhance customer experiences with Internet-based commerce.

To state the obvious to one familiar with the application domain—the current data exchange process presents Consumers with many problems.

a. No repository—Users currently don't create structured repositories of their data. When data is needed, they must gather the data from memory and various online and paper stores. Structured depositories don't exist primarily because users lack a mechanism to where they can be used.
b. No rapid transmission—Mechanisms to transmit this data quickly without retyping and wasting users time, do not exist or exist in some very limited form as browser tools that deal with this data in unstructured formats.
c. Repetitive Effort—Existing mechanisms for data reuse force users in becoming a member of the merchant's website or a member of another 3^{rd} party federation. Both instances require data sharing that consumers have become averse to.
d. Accuracy and Reliability—Since the data does not come from a data store, there are always issues and uncertainties around the validity of data, either typing mistakes or intentional tampering.
e. Intermediation—Many providers attempt to intermediate away these problems thereby creating another point where security issues must be addressed, causing increased costs, privacy concerns and unnecessary communication overheads.

There are a few current solutions to the problem. In the limited applications where only Personal (name, address, phone) or Credit Card data is required, current browsers are programmed to record this data when a consumer acquiesces. Such data is then provided when the browser's code observes the consumer interacting with a form where the stored data could be selected instead of having to be retyped.

A person with a little familiarity of the domain will discern the difficulties with the browser-based solutions. The technology used in the browsers is limited to a very small set of interactions that consumers undertake today. A vast majority of the form filling with arbitrary information relating to cars, homes, health, shopping needs, just to name a few, cannot possibly be stored in unstructured data formats created by the browser and possibly cause much confusion when being delivered into a form.

A person with a little familiarity of the domain will also discern the security problems associated with browser-based solutions. The data belonging to the consumer, presumably, very private as it pertains to private aspects of their lives, should not be stored in the browser, or with the browser company or in some third-party database, often without User's knowledge. In the current data privacy and security environment, with enhanced concerns on privacy and data use, these are significant stumbling blocks for a universally useful solution.

The present invention presents a unique and elegant solution to these data exchange problems specified above. All the data is secured on a user's computer, eliminating the incentives for someone to break into a consumer's computer to get at a single record which may or may not be valuable. Further, the data is encrypted in an easy to use fashion. When needed, the consumer can exchange any arbitrary personal data encoded into an Intrep-ID with an Intrep-ID compatible merchant. The exchange is secure, rapid and can be accomplished with little effort.

An easy to use encryption process is critical to the rapid exchange required/proposed by the present invention. A person familiar with the domain of the invention can immediately see that some personal data need not be secured for e.g. one's shoe size. One may not be disturbed if an external agent is able to gain access to this information. However, it is easily imagined that other data or information, even when stored on one's personal computer is capable of great damage in malicious hands.

An easy to use Encryption process being necessary for solving the problem of secure and rapid exchange of personal data, it is also critical that the encryption process be simple, transparent to the user of the technology and not require the use of encryption keys that have to be memorized. There exist many encryption algorithms for encrypting and storing sensitive information; our present invention is unique in that the encryption process does not require user intervention during the encryption/decryption process, critically enhancing the usability of the process and the system.

In the present invention, Intrep-IDs are implemented using a self-encrypting/decrypting process that doesn't require a previous user association, i.e. a key associated with a previously created user account. This unique methodology is enables “pretty good privacy” at a very low-cost threshold in terms of user effort to master and utilize it.

Just to elaborate and elucidate the technology and its applications better, the following scenarios illustrate the utility of the present invention. It will be obvious to anyone with even a limited familiarity with the domain that the following applications are a very small subset of the large numbers of applications that the technology can and should support.

a. Simple login Intrepid—This Intrepid helps customers create and use login Intrepids that they can use at their favorite websites. No need to remember any data, no need to reuse same username passwords, fully secure when encrypted.
b. Personal Information Intrepid—This Intrepid helps customers provide their personal information (Name, address, phone, email etc) to sites that need it.
c. Credit Card Intrepid—This Intrepid enables quick payments for online purchases.
d. Personal Medical Information Intrepid—This Intrepid when created stores users' personal medical information on their computers. When visiting their doctor, they simply upload their history to an application on the Doctor's website.
e. Customer Support Intrepid—When any product or service is purchased, a customer support Intrepid can be created and sent to the customer that outlines the service, any identifying account #s and other details of the object of the purchase. When support is required, the customer simply drops the Customer Support Intrepid from the provider on their website.
f. Political Donor Intrepid—Most political campaigns (and charity donation websites) have similar forms that users must fill out to donate. The political donor Intrepid can alleviate the pain of filling out these forms repeatedly when supporting a candidate or a cause over time.
g. Government Services Intrepid—This is a general class of Intrepids that support various citizen to Government data exchanges. These can be for car registrations, driver's license renewal, registering a business, requesting permits, paying taxes and any number of current applications that require users to repeatedly enter the same data on a monthly, quarterly or an annual basis.
h. Commercial Intrepids—In the linked Patent Application 16/423982, we describe a method and process for Broadband Procurement and Management. Intrepids are used in this application by Internet Service Provider (ISP) Reps to provide quotes to multiple customers requesting the same services. One, even with a limited knowledge of the possible domains, can understand that multiple similar applications exist that can utilize Intrepids.

Customer Service Management Framework—Introduced as a concept in [0016.e] Intrepids will be used to revolutionize customer service. Consumers purchase thousands of products and services each year. Each of these purchase events are represented by a paper or online receipt, a piece of unstructured data that cannot be reused. Using the present invention with its encryption technology, businesses can simplify and automate Customer Service and Support for many products and services in a safe and secure manner. This service and support framework, enabled by the present invention, is a unique feature of the invention itself.

### 3. Prior Art

Encryption Methods and technologies are vigorously represented in Prior Art. A subset of numerous Patent Citations related to “Self-Encryption”, but significantly different from the present invention, is tabulated.

| Citation | Title | Applicability To Present Invention |
|---|---|---|
| U.S. 13/930,729 | Multiple volume encryption of storage | Encryption of data on a hardware |
| | devices using self encrypting drive | device. Not related. |
| U.S. 11/493,912 | Data transfer device | Encryption of data on a hardware |
| | | device. Not related. |
| U.S. 13/410,282 | Methods, Systems, and Apparatuses | Encryption of data on a hardware |
| | for Managing a Hard Drive Security | device. Not related. |
| | System | |
| U.S. 13/229,765 | Managing self-encrypting drives in | Encryption of data on a hardware |
| | decentralized environments | device. Not related. |
| U.S. 12/985,488 | Secure distributed storage system | Encryption of data on a hardware |
| | and method | device. Not related. |
| U.S. 12/684,108 | Encryption bridge system and method | Encryption of data between a |
| | of operation thereof | computer and its storage system. |
| | | Not related. |
| U.S. 13/362,384 | Self-encryption process | Relating to protection of data and |
| | | resources among multiple |
| | | participants in a peer to peer |
| | | network. The present invention |
| | | relates to a single user and |
| | | protecting the single user data |
| | | to be made available as needed. |
| U.S. 12/402,786 | Password self-encryption method and | Relating to protecting passwords. |
| | system and encryption by keys | The algorithm supports the use of |
| | generated from personal secret | passwords; the present invention |
| | information | has no passwords. |
| U.S. 12/760,181 | Extensible management of self- | Relating to computer storage |
| | encrypting storage devices | systems, not applicable to the |
| | | current invention. |
| U.S. 11/263,455 | Recipient-encrypted session key | Related to cryptography using |
| | cryptography | session keys; the present |
| | | invention does not transmit keys. |

Patent Publications were also searched for “Personal Data Management”. This keyword resulted in many search results in Prior Art. A subset of the citations is shown below.

| Citation | Title | Applicability To Present Invention |
|---|---|---|
| U.S. 10/924,403 | Method, system, and program for | Data management to manage |
| | personal data management using | backup and redundancy of |
| | content-based replication | storage. Not related. |
| U.S. 12/540,269 | Personal data platform | Collection and management of |
| | | customer personal data. Not |
| | | related. |
| U.S. 13/683,566 | Personal data management system | Deals with a centralized global |
| | with global data store | store unlike disclosed inventions |
| | | customer storage. |
| U.S. 14/256,247 | Individual centric personal data | Deals with personal data |
| | management process and method | management; requires a central |
| | | server, requires public private |
| | | keys, a proprietary solution |
| | | targeted to specific industries. |

### BRIEF SUMMARY OF THE INVENTION

The present invention defines tools and methods to create and consume structured data, created and stored by consumers on their own devices and used directly with the merchants and service providers of their choice.

The invention embodies several unique ideas, namely, 1) enable users to create and manage structured repositories of their own arbitrary personal data that always remains under User's control, 2) To enable the rapid/easy delivery of the said data, when the data needs to be delivered to a party on the other side of a transaction, 3) To encrypt the said data in a manner that is transparent to the user, making it extremely easy to use.

Anyone with even a limited knowledge of the domain will understand that the present invention is unique in the ways described above, in that it combines a personal repository, structured data, user control, encryption and rapid transmission and interpretation, to achieve objectives and experiences sought by consumers. Critical to achieving these objectives is the ability to use their data, freely, rapidly and securely without creating a dependence on merchants and third parties; a process that introduces unnecessary complexity and cost.

As described below, with the exception of the Encryption/Decryption algorithm, the technologies underlying the present invention are NOT among the unique elements of the invention. The invention combines the Encryption/Decryption algorithm with existing web technologies to create an ecosystem of services that provide unique and significant value to users, consumers, service providers, merchants and the society at large.

### BRIEF DESCRIPTION OF THE FLOWCHARTS AND DIAGRAMS

The present invention will be more fully understood by referencing the following figures and flowcharts depicting detailed descriptions of the preferred embodiments. Wherein:

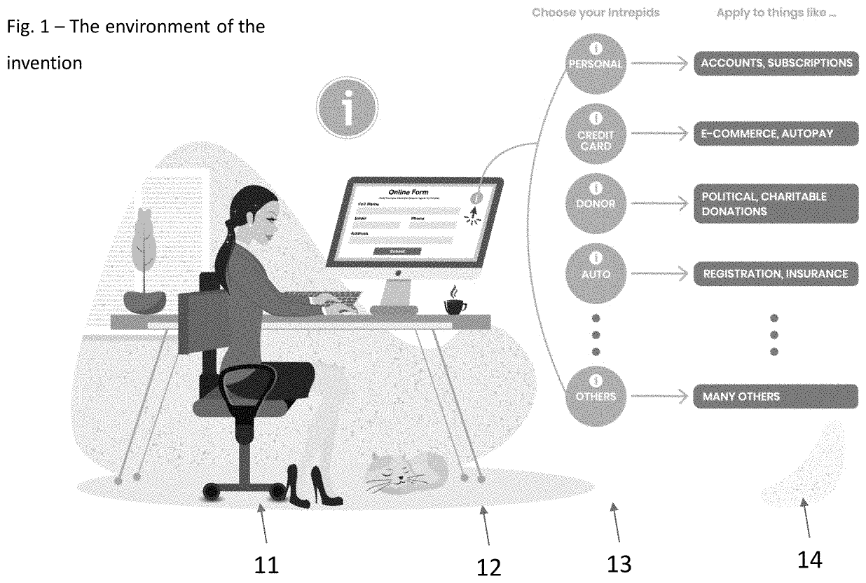

FIG. 1 is an abstraction of the actors in the field of the invention and shows the user/service environment in which the invention is deployed;

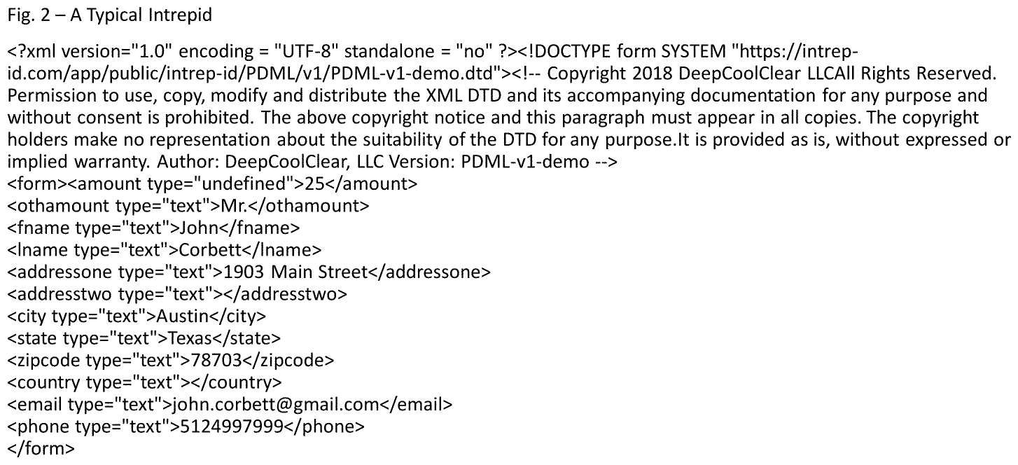

FIG. 2 an instantiation of an intrepid in one of the applications in the field of the invention. It shows that an intrepid is essentially an XML file conforming to a specific Intrepid vocabulary (DTD);

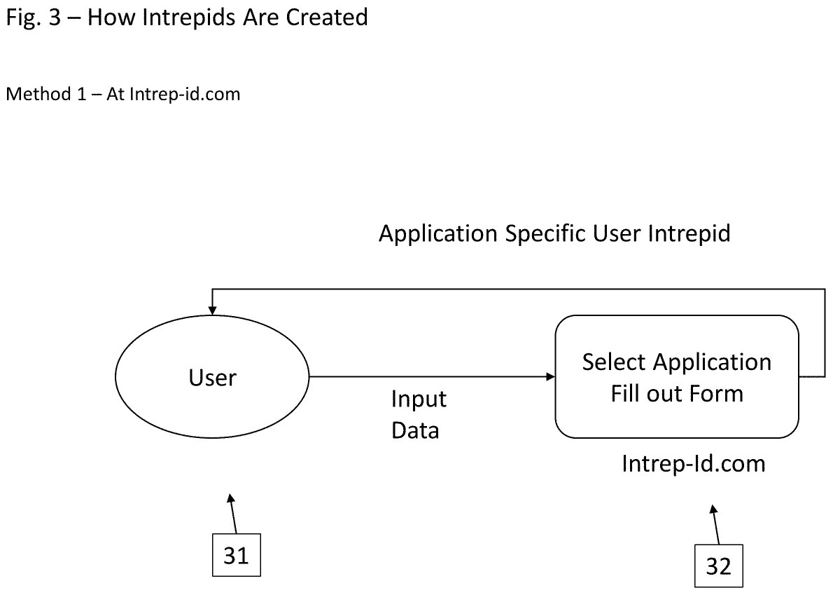

FIG. 3 depicts an abstracted process in the field of the invention showing a user creating an arbitrary Intrepid by filling out a form at Intrep-id.com;

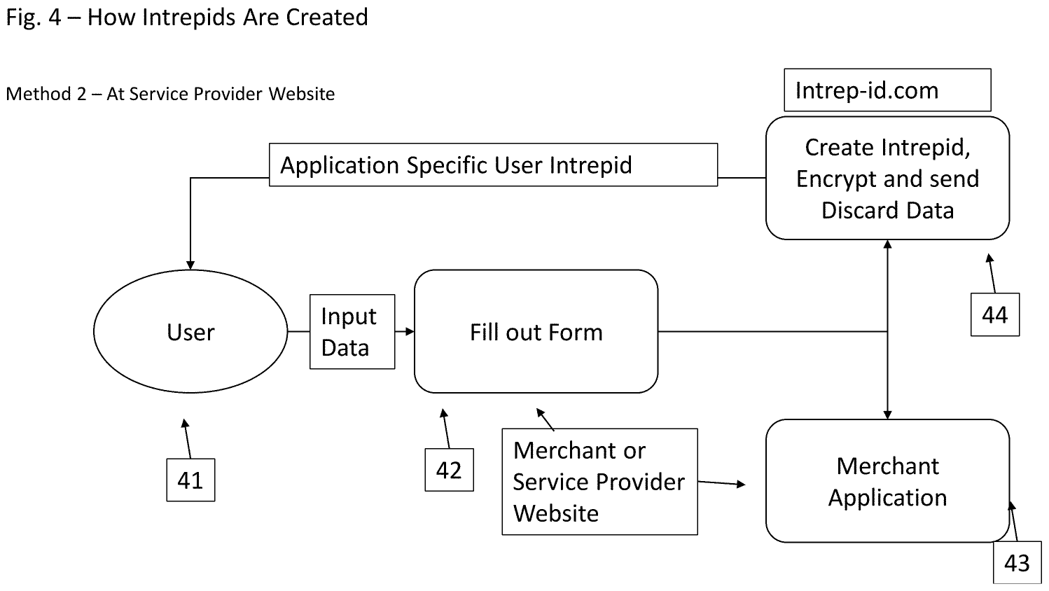

FIG. 4 depicts an abstracted process in the field of the invention showing a user creating an arbitrary Intrepid by filling out a form at a Merchant or an SP website;

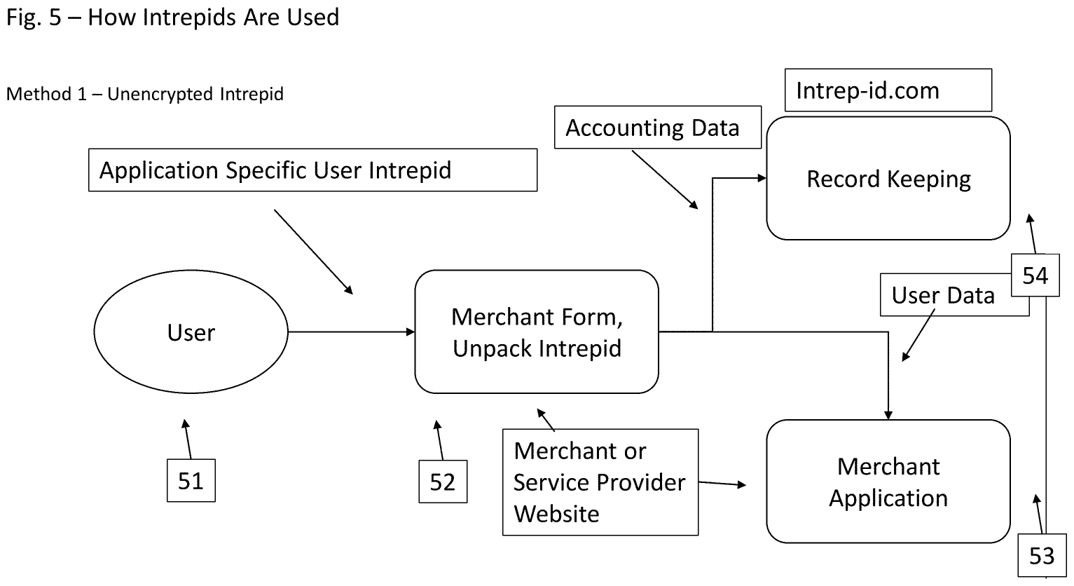

FIG. 5 is a flowchart of an abstracted process in the field of the invention. It depicts the use of a previously created an unencrypted Intrepid at a Merchant or an SP website, the process implicitly depicting a rapid reuse of customer data;

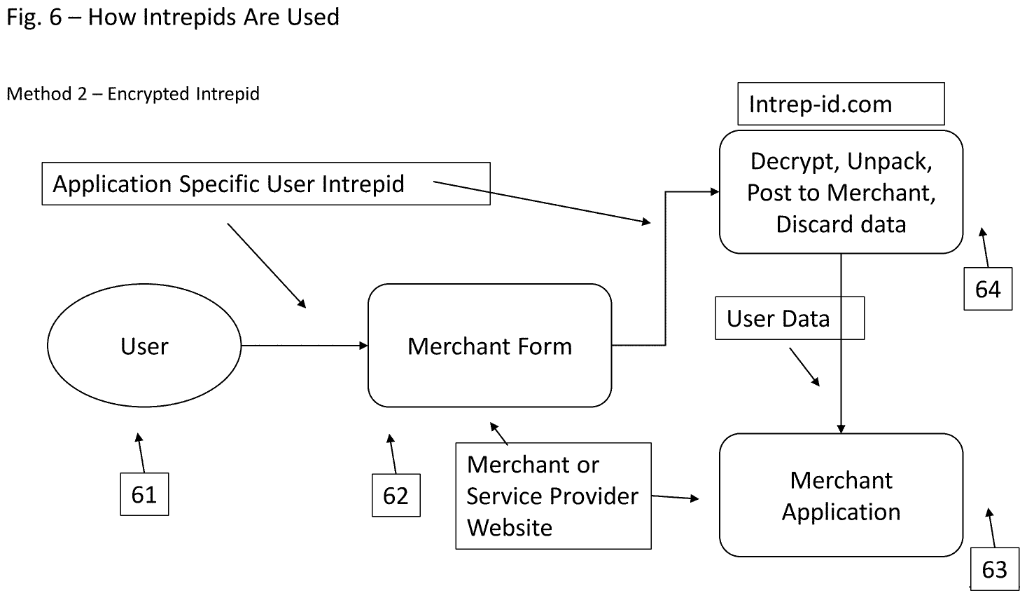

FIG. 6 is a flowchart of an abstracted process in the field of the invention. It depicts the use of a previously created Encrypted Intrepid at a Merchant or an SP website, the process implicitly depicting a rapid reuse of customer data;

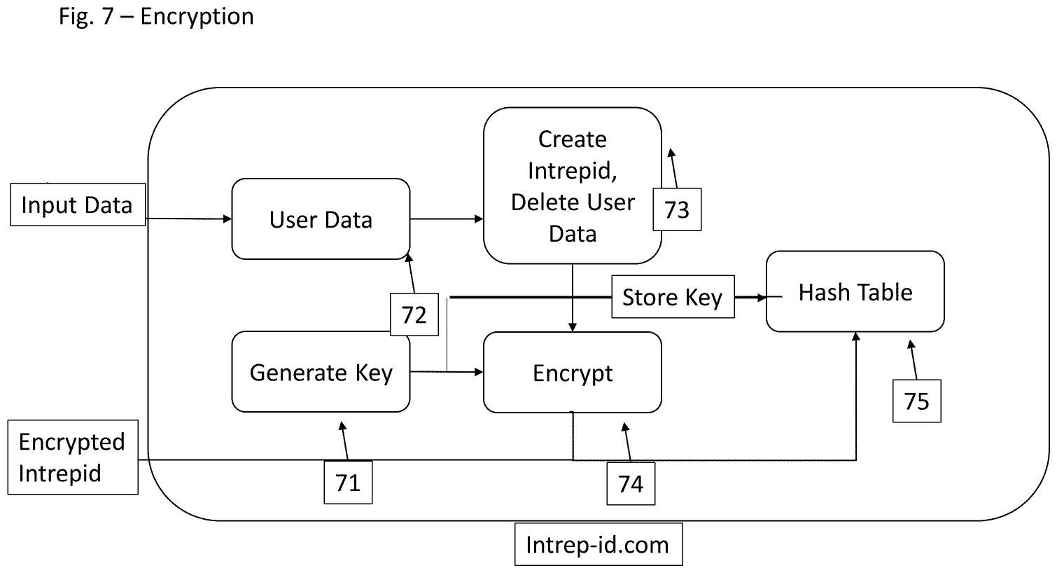

FIG. 7 is a flowchart of an abstracted process in the field of the invention. It depicts the creation of an encrypted Intrepid at intrep-id.com website whereby the data supplied by the user is transformed into an Encrypted Intrepid;

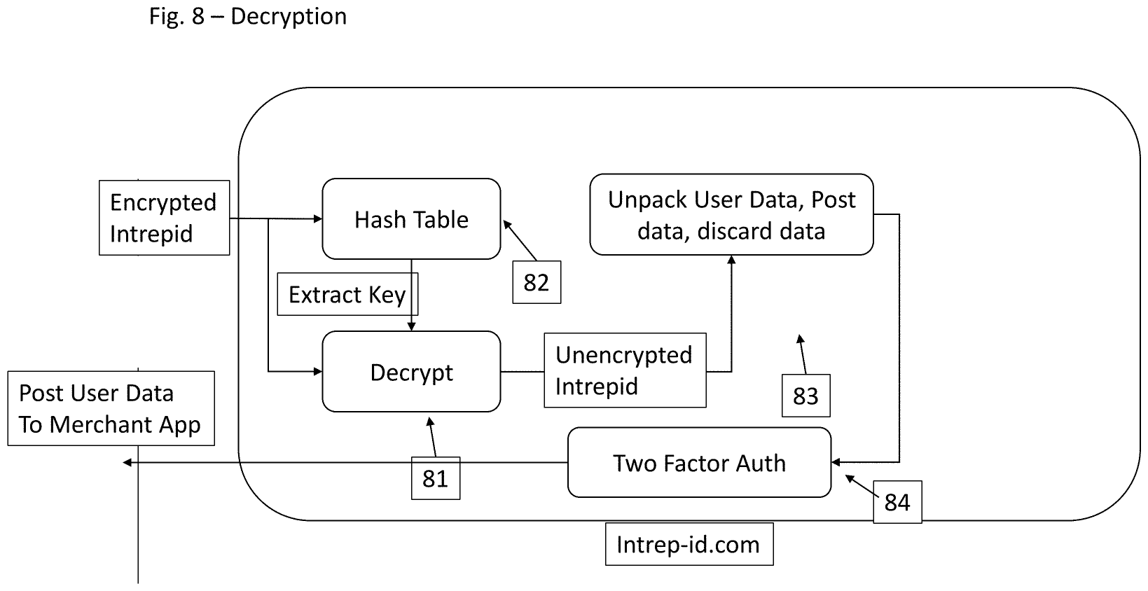

FIG. 8 is a flowchart of an abstracted process in the field of the invention. It depicts the decryption of an Encrypted Intrepid at intrep-id.com website whereby encrypted Intrepid supplied by the user is transformed into decrypted data and supplied to the SP application;

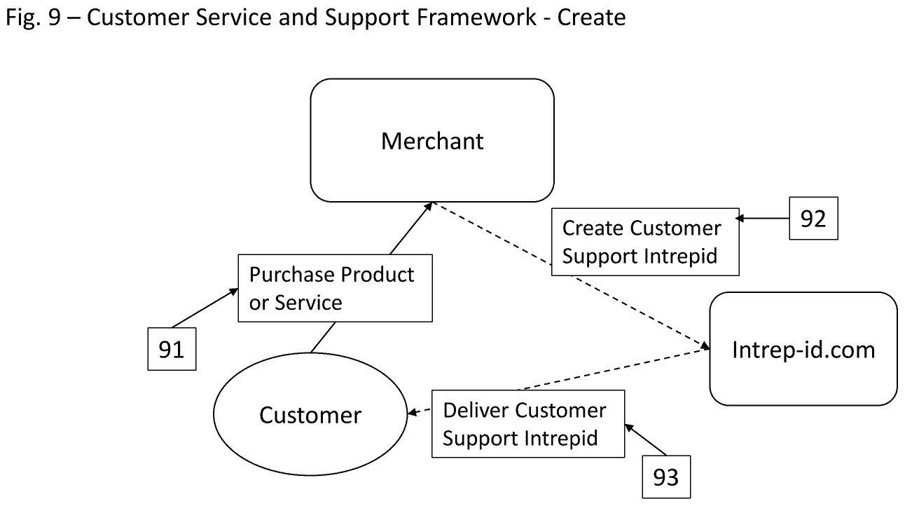

FIG. 9 is a flowchart of an abstracted process in the field of the invention. It depicts the creation of a generalized Customer Support Intrepid at the point of purchase. The user purchase data is transformed into an encrypted Intrepid that is delivered to the customer;

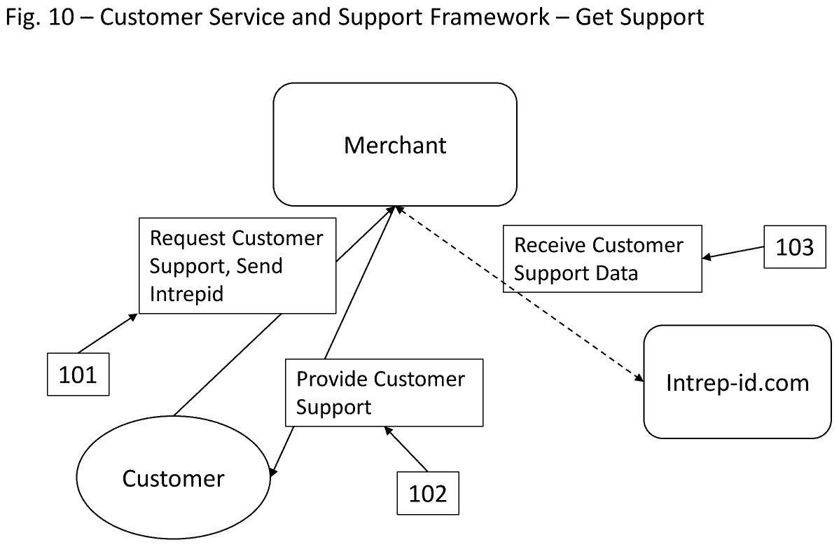

FIG. 10 is a flowchart of an abstracted process in the field of the invention. It depicts the use of a generalized Customer Support Intrepid to request customer support. The customer supplied Intrepid is decrypted into data meaningful to merchant applications. The same is used to provide support services;

The above figures are provided for the purpose of illustration and description only and are not intended to define the limits of the disclosed invention. The use of a specific User Interface is an embodiment and instance of the invention and one with ordinary skill can easily understand that changing the user interfaces as shown in the accompanied drawings does not change the core of the invention. The figures will be explained or will be within the skill of the art after the following teachings of the present invention have been read and understood.

### DETAILED DESCRIPTION OF THE INVENTION

As used herein, the term invention refers to the embodiment of features in the invented software system. As used herein, the term software system refers to the Intrep-ID.com software and website. Intrep-ID processes data contained in Intrepids that are instantiations of specific XML vocabularies, also known in the XML industry as DTDs.

The environment of the present invention is depicted in FIG. 1. The user (11) is at her desk preparing to provide some data to the web site (12) of interest. She encounters an invitation to use Intrepids, she clicks the link and selects from her Intrepid Repository (13) the specific Intrepid that contains the data required by the form. She selects the Intrepid, uploads it to the merchant web site, verifies the data that appears in the form and clicks Submit to send it to the Merchant application. It should be immediately apparent that the invention applies to not just one specific application but hundreds of applications/forms. For each of these applications, the User can select a specific, well-named Intrepid in her repository that contains relevant data to transfer to the Merchant for the specific purpose in the form.

FIG. 2 depicts the contents of an intrepid. As is evident to anyone familiar with XML technologies, there is nothing particularly interesting about this XML fragment other than the fact that the invention captures some data particular to this user in an XML fragment so it can be reused. Such fragments may be encrypted or unencrypted depending on the value of the contained data. It should be immediately apparent that the invention applies to not just one specific XML vocabulary or DTD, but hundreds of vocabularies structuring many aspects of User's life. For each of these DTDs, the User can create an instance with her personal data that she stores in her personal repository such that it is ready to be reused rapidly and securely.

FIG. 3 shows an abstracted process for creating an Intrepid at Intrep-ID.com (32). The user (31) interacts with the Intrep-id.com, selecting the Intrepid they are interested in. The form that the invention brings up shows the fields of data that constitute the intrepid. When the user provides the personal data as input to these forms, Intrep-id.com creates the application specific Intrepid and emails it to them. All input user data and the Intrepid instance is deleted after the Intrepid is transmitted to the User.

To appreciate ease of use further, consider that a Customer (41) in FIG. 4 may wish to create an Intrepid “in” the process of transacting with the Merchant (42) whose web site they happen to be browsing. In order to ease this data exchange in the future, the user clicks to the Intrepid application on the merchant web site, the link inviting them to create an Intrepid compatible with this application. The user fills out the Merchant Form (42) providing all the information necessary. When they subsequently click “Create Intrepid”, the data is packaged and sent to Intrep-id.com (44) where an Intrepid instance is created of the same data, encrypted as necessary and emailed to User. Upon successful transmission of the Intrepid, the user data is discarded at Intrep-id.com. The user can at this point “Submit” the form data to the Merchant Application (43) to achieve the present purpose.

FIGS. 5 and 6 depict the abstracted process that enables a user to use a previously created Intrepid. FIG. 5 shows the process for an unencrypted Intrepid, FIG. 6 shows the same for an encrypted Intrepid. It can be appreciated that from a User (51) perspective, the abstracted process is the same. The user uploads the Application specific Intrepid to the “Use Intrepid” link on the Merchant application (52). The Intrepid is transmitted to Intrep-ID.com where the Intrepid is unencrypted, the user data is unpacked and submitted to the said Merchant Application (53) for conducting User's business. It is understood that for unencrypted Intrepids, the present invention's Merchant side application component may be able to unpack the data on the Merchant server itself, transmitting only the Intrepid meta data to Intrep-Id.com website (54) for accounting purposes. In either method, user data is discarded when posted to the Merchant form.

In FIG. 6, the same essential abstracted process is depicted for Encrypted Intrepids. As the Intrepid is encrypted, the present Invention's Merchant side application component (62) defers the decryption to the Intrep-Id.com (64) by simply forwarding the entire Intrepid to Intrep-id.com. The Intrepid is decrypted, the user data is unpacked and posted to the Merchant Application (63) and the Application related meta data is recorded. When the data is posted back to the Merchant Application Form, Intrep-Id.com discards all user data.

At the core of the present invention is the Self Encrypting nature of the Intrepids. Without encryption, universal adoption of Interpids will be significantly adversely impacted as users will not be inclined to use unsecure methods for storing personal data. Widespread use will also be hampered if friction is introduced by asking users to create accounts on the intrep-id.com in order to provide the key to decrypt their Intrepids. The self-encrypting/decrypting nature of Intrepids eliminates these roadblocks and makes Intrepids truly usable. FIGS. 7 and 8 depicted an abstracted process in the invention that creates a unique encryption and decryption method.

FIG. 7 depicts the Encryption process. Users provide User Data (72) either directly at Intrep-id.com website or the User Data is transmitted to Intrep-id.com from the Merchant Website. In either case, an Application specific Intrepid is created at Intrep-Id.com (73) and the user data is discarded. The Encryption process then generates a random Encryption Key (71) which is used to encrypt the Intrepid just created (74). The resulting bits of the encrypted Intrepid are then hashed into specific location in the Application Hash Table, wherein the Encryption Key used to encrypt this Intrepid is stored. The encrypted Intrepid is transmitted to the User and the Intrepid and related User data is deleted.

FIG. 8 depicts the Decryption process. Upon delivery of the Encrypted Intrepid to Intrep-id.com, the encrypted bits are hashed into the Application Hash Table (82) using the hashing algorithm. The Encryption Key is extracted from that location and used to decrypt the encrypted Intrepid (81). The unencrypted Intrepid is then unpacked at Intrep-id.com (83), the resulting User Data is posted to the Merchant Application form, and, upon successful transmission of the data, the User data is deleted.

For additional security, the Intrepid server automatically verifies users by deploying a “two factor authentication system” (84). No encrypted user data is displayed to the sending client until the client can verify that it is the “owner” of the data via SMS (Short Messaging System used by many cellular service providers) or Email. The Owner's SMS phone number and Email address are a part of all Intrepids. This authentication eliminates/minimizes possibilities of fraud and ensures that Merchants or Service Providers are guaranteed authenticated data when presented to them.

FIG. 9 and FIG. 10 depict an important application of the Intrepid System. Significant manual effort is devoted by businesses today to ensure and authenticate their customers/users requesting support or post purchase services. This entails several query/responses with codes, social security numbers, and other identifiers. When we replace the phone-based support requests with Intrepid support requests, authentication is automatic. Using Intrepids, it is possible to eliminate the human interaction that needs to proceed before the Merchant computer systems process and fulfill the request.

FIG. 9 shows a Merchant/SP collecting and creating the product data required for subsequent service and support requests at the point of sale (91). The Merchant/SP then sends to Intrep-id.com this data (92), whereupon a well-named Customer Support Intrepid is created and emailed to the user (92). The user data and the related Intrepid is then deleted.

FIG. 10 depicts a Customer requesting support at a Merchant website by delivering their customer support Intrepid to the Merchant (101). The Merchant sends it to Intrep-id.com (103), where the Intrepid is decrypted, and the user data is presented to the Merchant application which provides Customer the support that was requested. The user data and the Intrepid at Intrep-id.com is deleted when data is delivered to the Merchant.

The security advantages of the Self Encryption process of the present invention are enumerated below.
a. The encrypted data and the encryption key are never co-located except momentarily at the Intrep-id.com only in the process of being encrypted and decrypted.
b. The encryption key is arbitrarily large and random making it “expensive” for someone to use brute force to decrypt an Intrepid they have in their possession illegitimately.
c. An illegitimately procured Intrepid cannot used at a Merchant Website or at Intrep-ID.com to display critical information without authenticating the user using the 2 Factor authentication system.
d. There is no actual user data at Intrep-ID.com. A website intrusion, if successful, merely delivers to the intruder a set of random keys without the data to which they can be applied. Such an intrusion is of no use to the intruder.
e. The Self Encryption Process as described in the present invention makes the effort of breaking the algorithm highly “unprofitable” for the intruder as all the effort, even if it were completely successful, will at best provide them with a single data set. The efforts to procure large numbers of data sets will involve replicating the effort a vastly larger number of times.

The uniqueness of Intrep-Id, the present invention is enumerated below:
f. Intrep-id provides a structured repository for arbitrary personal and business data of consumers.
g. Intrep-Id provides a rapid transmission mechanism of this personal and business data to merchants and service providers users wish to do business with.
h. Intrep-id provides an innovative encryption mechanism that wraps the Intrepids in a security layer without which significant barriers would be placed in the path of widespread use; this security layers presents minimum overhead to users using Intrepids.
i. A Customer Support/Service Framework is created and made possible using Intrepids.

We claim:

1. A system and a process for Personal Data Management, the process comprising:
all steps that together enable the creation and management of repositories of structured personal and business data for individual consumers and users; XML vocabularies that create structure around personal and business data belonging to users; creating well defined instances (Intrepids) that encapsulate this structured data; naming schemes that enable users to store and retrieve the said Intrepids easily on their own devices; all steps that enable the secure and rapid transmittal of such structured data from a consumer's device to the receiving merchant of their choice; all steps that enable the creation and deployment of tools that enable the easy and rapid installation of Intrepid receiving software on Intrepid receiving site; all steps being applicable to user devices, computers, laptops, and smart mobile phones; transmittal and storage of Intrepid meta data to enhance understanding and promote usage; and

2. A system for encrypting Intrepid data comprising:
a self-encryption method for self-encrypting structured User data without requiring User authentication; To encrypt a random key is generated; the data to be secured is encrypted using the key; the resulting encoded data is then hashed into the Application Hash table; the encryption key is stored into the Application Hash table; and
a self-decryption method for self-decrypting structured User data without requiring User authentication; The encrypted user data is hashed into a hash table; the encryption key is retrieved from the hash table at the location; the encoded data decrypted using the key; the user data is provided to the requesting site and discarded; a two factor authentication system further protects the user data; and

3. A system and a process for creating a customer support and service framework:
all steps together that capture user data at the point of sale; all steps that create a structured customer service and support repository for the customer; all steps that enable the delivery of such structured data back to the merchant at the time service or support is needed; all steps necessary to authenticate and validate the Customer; all steps necessary to enable the delivery of the support/service requested by the Customer
